(19) United States
(12) Patent Application Publication
(10) Pub. No.: US 2026/0021731 A1
(43) Pub. Date: Jan. 22, 2026

(54) AUTOMATIC CHARGING ROBOT AND CHARGING SYSTEM

(71) Applicant: TOYOTA JIDOSHA KABUSHIKI KAISHA, Toyota-shi Aichi-ken (JP)

(72) Inventors: Hironaga ONO, Toyota-shi Aichi-ken (JP); Ritsu NISHIMURA, Nagoya-shi Aichi-ken (JP); Hiroaki NISHINO, Toyota-shi Aichi-ken (JP); Yohei ONO, Nisshin-shi Aichi-ken (JP); Ryohei CHINO, Nisshin-shi Aichi-ken (JP); Shimpei ISOBE, Toyota-shi Aichi-ken (JP); Manabu HIROSE, Okazaki-shi Aichi-ken (JP)

(73) Assignee: TOYOTA JIDOSHA KABUSHIKI KAISHA, Toyota-shi Aichi-ken (JP)

(21) Appl. No.: 19/268,193

(22) Filed: Jul. 14, 2025

(30) Foreign Application Priority Data
Jul. 19, 2024 (JP) 2024-115773

(51) Int. Cl. B60L 53/37; B60L 53/16; B60L 53/18; B60L 53/60; H01R 43/26; H02G 11/02

(52) U.S. Cl. CPC B60L 53/37; B60L 53/16; B60L 53/18; B60L 53/60; H01R 43/26; H02G 11/02

(57) ABSTRACT

An automatic charging robot includes: an arm mechanism configured to grip a charging connector connected to a charging device via a charging cable; a control device configured to automatically perform control of an operation of the arm mechanism; and a dynamic sensor provided in the arm mechanism and configured to detect an overload due to catching of the charging cable. The control device is configured to control the operation of the arm mechanism to: return to a previous one or two operations when the overload has been detected by the dynamic sensor; and return to the operation when the overload has been detected after the overload is released.

### CROSS-REFERENCE TO RELATED APPLICATION

The present application claims priority to and incorporates by reference the entire contents of Japanese Patent Application No. 2024-115773 filed in Japan on Jul. 19, 2024.

### BACKGROUND

The present disclosure relates to an automatic charging robot and a charging system.

JP 2020-072625 discloses a charging device charging cable having a charging plug is one or more connected to the apparatus main body, grasp any charging plug provided in the charging device, with respect to the charging port of the vehicle located in the charging space, the charging system comprising an arm mechanism for automatically performing the insertion and removal of the charging plug.

### SUMMARY

However, during the operation of the arm mechanism that grasps the charging connector (charging plug), there is a possibility that the operation of the arm mechanism is stopped by the charging cable is caught.

There is a need for an automatic charging robot and a charging system capable of suppressing the operation of the arm mechanism is stopped by the charging cable is caught.

According to one aspect of the present disclosure, there is provided an automatic charging robot including: an arm mechanism configured to grip a charging connector connected to a charging device via a charging cable; a control device configured to automatically perform control of an operation of the arm mechanism; and a dynamic sensor provided in the arm mechanism and configured to detect an overload due to catching of the charging cable, wherein the control device is configured to control the operation of the arm mechanism to: return to a previous one or two operations when the overload has been detected by the dynamic sensor; and return to the operation when the overload has been detected after the overload is released.

According to another aspect of the present disclosure, there is provided an automatic charging robot including: an arm mechanism configured to grip a charging connector connected to a charging device via a charging cable; a control device configured to automatically perform control of an operation of the arm mechanism; and a camera provided in the arm mechanism and configured to capture an image regarding to catching of the charging cable and generate image information based on the captured image, wherein the control device is configured to calculate a direction to operate the arm mechanism for releasing the catching of the arm mechanism based on the image information, and control the arm mechanism to perform an operation to release the catching of the charging cable based on the calculated direction.

According to still another aspect of the present disclosure, there is provided an automatic charging robot including: an arm mechanism configured to grip a charging connector connected to a charging device via a charging cable; a control device configured to automatically perform control of an operation of the arm mechanism; and a cable winder configured to wind the charging cable, wherein the control device is configured to control the cable winder to pull out the charging cable with a minimum necessary length.

### BRIEF DESCRIPTION OF THE DRAWINGS

FIG. 1 is a block diagram illustrating a schematic configuration of a charging system according to a first embodiment;

FIG. 2 is a perspective view illustrating a schematic configuration of a charging system according to the first embodiment;

FIG. 3 is a plan view illustrating a schematic configuration of a charging system according to the first embodiment;

FIG. 4 is a side view illustrating a schematic configuration of a charging system according to the first embodiment;

FIG. 5 is a flowchart illustrating the overall flow of the charging method executed by the charging system according to the first embodiment;

FIG. 6 is a flowchart illustrating an example of the control of the abnormal treatment operation performed by the control unit of the automatic charging robot in the charging system according to the first embodiment;

FIG. 7 is a side view illustrating a schematic configuration of a charging system according to a third embodiment; and

FIG. 8 is a flowchart illustrating an example of the control of the abnormal treatment operation performed by the control unit of the automatic charging robot in the charging system according to a second embodiment.

### DETAILED DESCRIPTION

Hereinafter, a first embodiment of a charging system equipped with an automatic charging robot according to the present disclosure will be described. Note that the present disclosure is not limited by the embodiments.

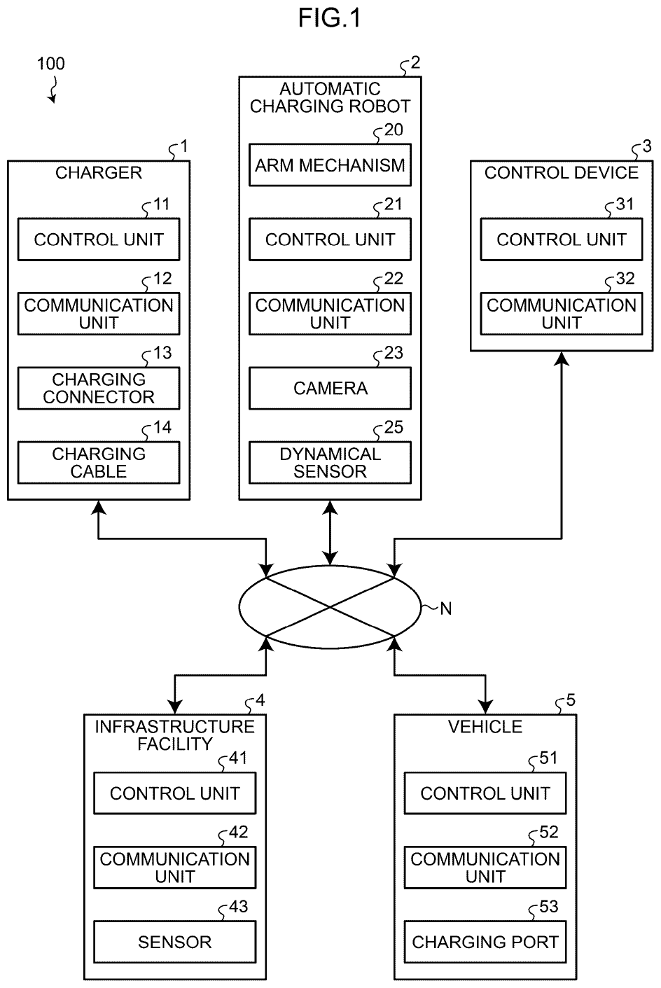

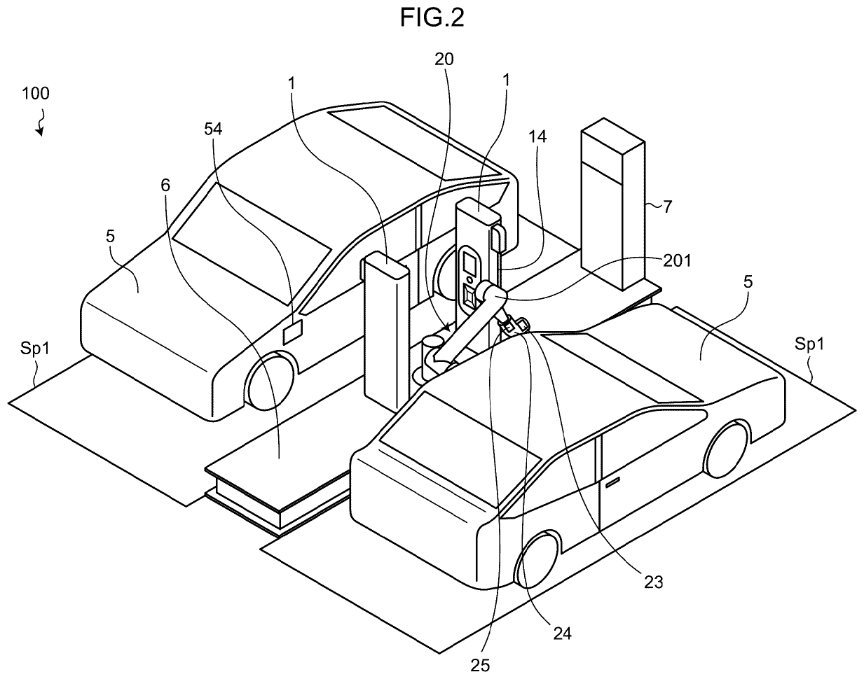

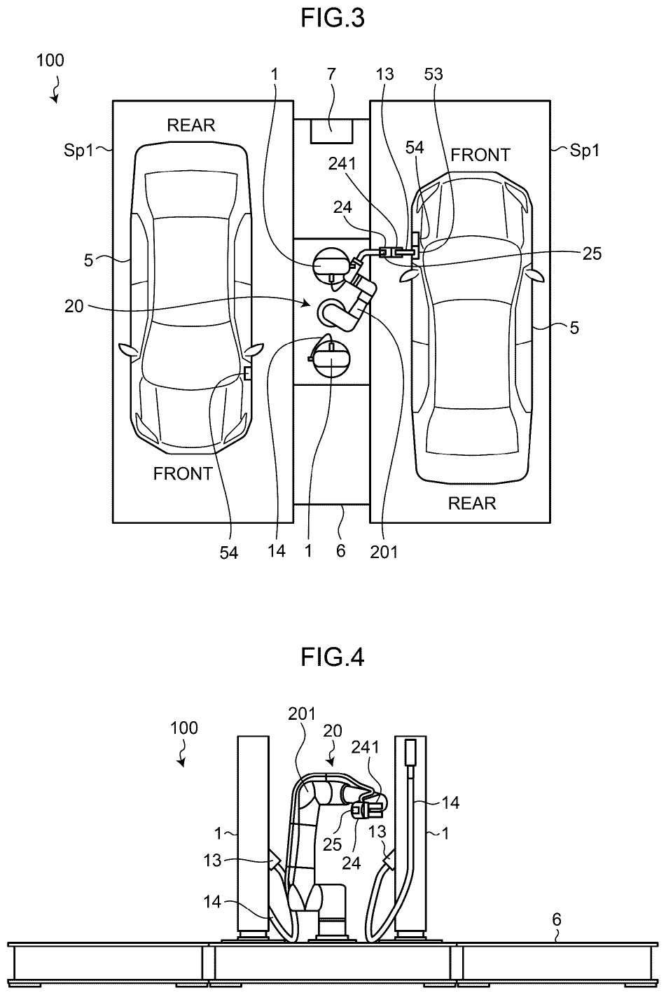

FIG. 1 is a block diagram showing a schematic configuration of a charging system 100 according to the first embodiment. FIG. 2 is a perspective view showing a schematic configuration of a charging system 100 according to the first embodiment. FIG. 3 is a plan view showing a schematic configuration of a charging system 100 according to the first embodiment. FIG. 4 is a side view showing a schematic configuration of a charging system 100 according to the first embodiment.

A charging system 100 according to the first embodiment, for example, using a charger installed in a parking lot, is for charging a plurality of vehicles at the same time. The charging system 100 according to the first embodiment, as shown in FIG. 1 has a charger 1, the automatic charging robot 2, the control device 3, the infrastructure facility 4, and the vehicle 5. The charger 1, the automatic charging robot 2, the control device 3, the infrastructure facility 4 and the vehicle 5 are provided with a communication function, and they communicate with each other through the network N, and are configured to be able to exchange various types of information. The network N is composed of, for example, an Internet line network, a cellular phone line network.

The charger (charging station, charging post) 1 is a charging device for supplying power to the vehicle 5 to be charged. The charger 1 is installed on the frame 6 as shown in FIGS. 2 to 4. Further, the charger 1 is connected to the control panel 7. The control panel 7 is connected to, for example, a substation facility (cubicle) for transforming power from the power plant.

The charger 1, as shown in FIG. 1, includes a control unit 11, a communication unit 12, a charging connector 13, and a charging cable 14.

The control unit 11, for example, is realized by consisting of a processor made of a central processing unit (CPU) or the like, and a memory (main storage unit) such as a read only memory (ROM), a random-access memory (RAM) or the like. The control unit 11 supplies power to the vehicle 5 to be charged based on an instruction from the control unit 3.

The communication unit 12, for example, is consisting of a local area network (LAN) interface board, a wireless communication circuitry for wireless communication, and the like. The communication unit 12 communicates with, for example, the automatic charging robot 2 and the control device 3 through the network N.

The charging connector (charging gun, charging plug) 13 is for supplying power to the vehicle 5 to be charged. The charging connector 13 is engaged with the side surface of the charger 1 during non-charging. Then, the charging connector 13, when the start of charging to the vehicle 5 is started, it is grasped by the automatic charging robot 2 of the fixed type, is inserted into the charging port 53 of the vehicle 5. In this state, through the charging connector 13, power is supplied from the charger 1 side to the vehicle 5 side. Thereafter, when the charging of the vehicle 5 is completed, the charging connector 13 is again grasped by the automatic charging robot 2, after being withdrawn from the charging port 53 of the vehicle 5 is engaged with the side surface of the charger 1.

The infrastructure facility 4 includes a control unit 41, a communication unit 42, and a sensor 43. The vehicle 5 includes a control unit 51, a communication unit 52, and the charging port 53.

In FIGS. 2 to 4, an example in the case where one charging connector 13 is provided for one charger 1 is shown, a plurality of charging connector 13 for one charger 1 may be provided.

The charging cable 14 is provided between the charging connector 13 and the charger 1 (charger body). The charging cable 14, regardless of the position of the charging port 53 in the vehicle 5 is constituted by a length capable of inserting the charging connector 13 into the charging port 53. For example, in FIG. 3, it shows an example in which the charging port 53 is disposed on the left front of the vehicle 5, depending on the type of vehicle, the charging port 53 on the left side rear of the vehicle 5, the center front, there is a case where it is disposed such as the center rear. Therefore, the charging cable 14, the left front of the charging port 53 of the vehicle 5, the left rear, the center front, even when it is arranged in any of the center rear, the charging connector 13 is configured in a length that can be inserted.

Incidentally, depending on the vehicle type of the vehicle 5, the charging port 53 is the right front of the vehicle 5, there is a case that is disposed on the right rear. In this case, for example, in FIG. 3, parking the vehicle 5 of the left and right charging space Sp1 in the longitudinal opposite direction, respectively charging toward the charging port 53 in the direction of the charger 1. For example, the vehicle 5 on the right side of FIG. 3, the vehicle front is the lower drawing, the vehicle rear is parked in the charge space Sp1 so as to face the upper drawing surface. Further, the left vehicle 5, the vehicle front is on the drawing, the vehicle rear is parked so as to face the lower side of the drawing.

The automatic charging robot 2, when performing charging from the charger 1 to the vehicle 5 is for performing the insertion and removal to the charging port 53 by gripping the charging connector 13 automatically.

As shown in FIG. 1, the automatic charging robot 2 includes an arm mechanism 20, a control unit 21, a communication unit 22, a camera 23, a dynamics sensor 25, and a driving device.

The base end portion of the arm mechanism 20 is installed and fixed on the frame 6. The arm mechanism 20 is provided on the arm tip 24 is a distal end portion of the robot arm 201 having a plurality of articulated portions, and has a robot hand 241 capable of gripping the charging connector 13.

The control unit 21, for example, is a control device realized by a processor made of a CPU, and a memory (main storage unit) consisting of RAM and ROM. The control unit 21, based on an instruction from the control unit 3, automatically controls the drive unit, grasps the charging connector 13 by the robot hand 241 of the arm mechanism 20, inserts the charging connector 13 to the charging port 53, and takes out the charging connector 13 from the charging port 53. Namely, the control unit 21, based on an instruction from the control device 3, automatically performs control for operating the arm mechanism 20. Further, the control unit 21, for example, is disposed in the proximal end portion of the arm mechanism 20.

Further, the control unit 21 identifies the position of the charging port 53 and the distance to the charging port 53 (the distance between the charging connector 13 and the charging port 53) from the image captured by the camera 23 installed at the tip of the automatic charging robot 2 when inserting the grasped charging connector 13 to the charging port 53. The shape of the charging port 53 of the vehicle 5 is normalized. Therefore, the position of the charging port 53 can be identified by performing pattern matching based on the image of the charging port 53 captured by the camera 23. Further, the distance from the charging connector 13 which the auto-charging robot 2 is gripping to the charging port 53, using a 3D (three-dimensional) camera as the camera 23, by acquiring information in the depth direction, it can be specified.

The communication unit 22 is composed of, for example, a LAN interface board, a wireless communication circuitry for wireless communication, and the like. The communication unit 22 communicates with the charger 1 and the control device 3 through the network N, for example.

Further, the communication unit 22, for example, is disposed in the proximal end portion of the arm mechanism 20.

The camera 23 images the charging port 53. The Camera 23 is provided at the tip of the automatic charging robot 2 (arm mechanism body). The camera 23 is, for example, is configured to communicate with the control unit 21 via the communication cable. In embodiments, the camera 23 may be a 3D camera capable of acquiring information in the depth direction.

The controller 3 controls the charger 1, the automatic charging robot 2 and a plurality of vehicles 5. The control device 3 performs, for example, charging control of the charger 1, the control of the operation of the automatic charging robot 2, the control of the infrastructure facility 4, the running control of the vehicle 5 and the like. The controller 3 may be implemented, for example, by a general-purpose computer such as a workstation or a personal computer, or by a server located on a cloud. Incidentally, the control device 3, the control target (charger 1, automatic charging robot 2, infrastructure facility 4, and vehicle 5) may be constituted by separate hardware in accordance with.

Further, of the control device 3, a function of performing charging control of the charger 1, the control panel 7 may be responsible.

The control device 3 includes, as illustrated in FIG. 1, a control unit 31 and the communication unit 32.

The control unit 31 is realized by, for example, a processor such as a CPU, and a memory (main storage unit) such as a RAM and/or a ROM. The following describes the specific processing contents of the control unit 31.

The control unit 31, based on the information acquired from the infrastructure facility 4 (e.g., position information of the vehicle 5, etc.), performs travel control of the vehicle 5. For example, the control unit 31 receives the charging reservation of the vehicle 5 from the user of the vehicle 5 (e.g., the driver). The charging reservation may be accepted based on information input to the information terminal carried by the user (e.g., a smartphone connected to the network N), or the user may be accepted based on information input to the in-vehicle terminal (e.g., a car navigation connected to the network N).

When the order of charging of the vehicle 5 is approaching, the control unit 31, by using the positional information of the vehicle 5 acquired from the infrastructure facility 4, after the vehicle 5 is automatically driven from the parking space in which the vehicle 5 is parked to the standby space, it is automatically parked.

Thus, by waiting to move the vehicle 5 to be charged to the standby space in advance, it is possible to minimize the replacement time of the vehicle 5 to perform charging, it is possible to improve the operation rate of the charger 1. Subsequently, when the order of charging the vehicle 5 arrives, the control unit 31, by using the positional information of the vehicle 5 acquired from the infrastructure facility 4, after automatically traveling the vehicle 5 from the standby space to the charging space Sp1, to automatically park. Then, the control unit 31 is caused to grip the charging connector 13 by the automatic charging robot 2, the charging connector 13 which is gripped is inserted into the charging port 53 by the automatic charging robot 2, to start charging by the charger 1.

Subsequently, when the charging of the vehicle 5 is completed, the control unit 31 is a charging connector 13 to the automatic charging robot 2 is again grasped, withdrawn from the charging port 53 the charging connector 13 which is the grasped by the automatic charging robot 2.

Subsequently, the control unit 31 uses the positional information of the vehicle 5 acquired from the infrastructure facility 4, after automatically traveling the vehicle 5 from the charging space Sp1 to the standby space, to automatically park.

The control unit 31 control the vehicle 5 to make the charging port 53 face the charger 1 when parking the vehicle 5 in the charging space Sp1. For example, when charging the vehicle 5 with the charging port 53 disposed on the left front, as shown in FIG. 3, in the charging space Sp1 on the right side of the charger 1, the control unit 31 control the vehicle 5 to park such that the charging port 53 is positioned on the left, the vehicle front faces toward the upper side of the drawing and the vehicle rear faces toward the lower side of the drawing. Conversely, as for the charging space Sp1 on the left side of the charger 1, the control unit 31 control the vehicle 5 to park such that the charging port 53 is positioned on the right, the vehicle front faces toward the lower side of the drawing and the vehicle rear faces toward the upper side of the drawing.

Incidentally, depending on the vehicle type of the vehicle 5, opposite to FIG. 3, there is a case where the charging port 53 is disposed on the right front and right rear of the vehicle 5. In this case, for example, in the example of two vehicles 5 shown in FIG. 3, the charging space Sp1 on the right side of the charger 1, the vehicle 5 is parked such that the charging port 53 is positioned on the left, the vehicle front toward the lower side of the drawing, and the vehicle rear toward the upper side of the drawing. Conversely, as for the charging space Sp1 on the left side of the charger 1, the vehicle 5 is parked such that the charging port 53 is positioned on the right, the vehicle front toward the upper side of the drawing and the vehicle rear toward the lower side of the drawing.

The control unit 31, using a single automatic charging robot 2, is capable of charging two or more vehicles 5 at the same time. In this instance, the control unit 31 moves the first vehicle 5 (hereinafter, referred to as “vehicle A”) to a predetermined position (charge space Sp1 on the right side of the drawing surface). Subsequently, the control unit 31 causes the automatic charging robot 2 to grip the charging connector 13 of the first charger 1 (charger 1 on the upper side of the drawing). Subsequently, the control unit 31, the charging connector 13 which is gripped by the automatic charging robot 2, is inserted into the charging port 53 of the vehicle A, to start the charging of the vehicle A.

Subsequently, the control unit 31 moves the second vehicle 5 (hereinafter, referred to as “vehicle B”) to a predetermined position (charge space Sp1 on the left side of the drawing surface). Subsequently, the control unit 31, the automatic charging robot 2 to grip the charging connector 13 of the second charger 1 (charger 1 of the lower side of the drawing). Subsequently, the control unit 31, during charging of the vehicle A, the charging connector 13 which is grasped by the automatic charging robot 2, is inserted into the charging port 53 of the vehicle B, to start the charging of the vehicle B.

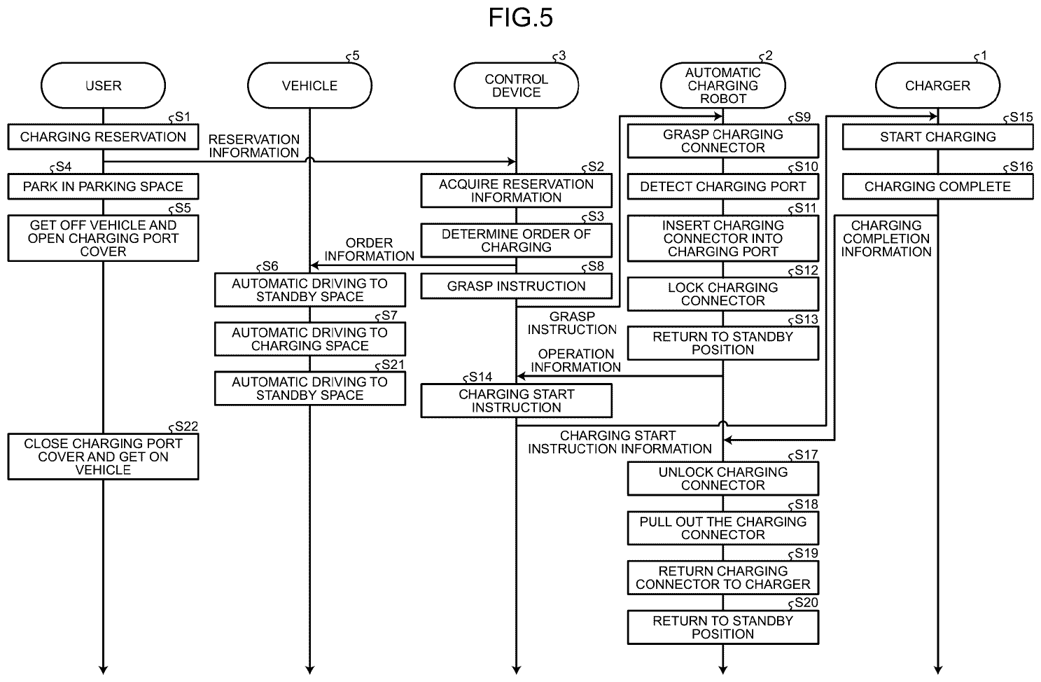

FIG. 5 is a flowchart showing the overall flow of a charging method executed by the charging system 100 according to the first embodiment.

First, the user makes a charge reservation (Step S1). The charging reservation may be performed, for example, through an information terminal possessed by the user (e.g., a smartphone connected to the network N, etc.), or may be performed through an in-vehicle terminal (e.g., a car navigation system connected to the network N, etc.).

Subsequently, the control unit 3 acquires the reserved information of the charge from the above-described information terminal or the in-vehicle terminal or the like (Step S2). This reservation information includes information necessary for charging the vehicle 5 by the charger 1.

The reservation information includes, for example, information for specifying a user (for example, a user ID, etc.), information on the transmission date and time of the charging reservation, and information on the date and time that the charging is desired. The reservation information also includes information for specifying the vehicle 5 (e.g., vehicle number, etc.), information about the position of the charging port 53 of the vehicle 5, information about the remaining battery capacity of the vehicle 5 (SOC: State of Charge), and the present position of the vehicle 5. Incidentally, the information about the position of the charging port 53, for example, the charging port 53, left front of the vehicle 5, left rear, right front, right rear, center front, is information about where among the center rear.

Subsequently, the control device 3 determines the order of charging of the vehicles 5 that have received the reservation (Step S3). In Step S3, for example, the number of other vehicles 5 that have received the charging reservation at the same time or before and after the time, and, based on such time from the remaining battery capacity of the other vehicle 5 to the predicted charging completion, determining the order of charging of the vehicle 5. Further, in Step S3, the control device 3, the information about the determined order (order information), and transmits to the vehicle 5 (and the information terminal of the user, the in-vehicle terminal).

Subsequently, the user parks the vehicle 5 in the parking space of the parking lot (parking lot charger 1 is installed) (Step S4). Subsequently, after getting out of the vehicle 5, the user opens the charging lid 54 and the charging port cover (Step S5), and leaves the parking space.

Subsequently, the vehicle 5 automatically travels from the parking space to the standby space based on an instruction of the control device 3 (Step S6). Then, when the order of charging arrives, the vehicle 5 automatically travels from the standby space to the charging space Sp1 on the basis of an instruction of the control device 3 (Step S7).

When the vehicle 5 is stopped in the charging space Sp1, the control device 3, to the auto-charging robot 2, transmits an instruction to grip the charging connector 13 (grasp instruction) (Step S8). In response to this, the auto-charging robot 2 grasps the charging connector 13 by the arm mechanism 20 (Step S9), to move the charging connector 13 to the vicinity of the charging port 53.

Subsequently, the auto-charging robot 2, for example, by pattern matching based on the image information of the charging port 53 captured by the camera 23, detects the position of the charging port 53 (Step S10), and inserts the charging connector 13 into the charging port 53 (Step S11).

Subsequently, the automatic charging robot 2, so that the charging connector 13 does not come off from the charging port 53, the charging connector 13 by a locking mechanism or the like to the charging port 53 (vehicle 5) locked (Step S12), the grip of the charging connector 13 by the arm distal end portion 24 of the arm mechanism 20 release to return to a predetermined standby position (Step S13). Incidentally, the “predetermined standby position”, for example, as shown in FIG. 1, a state in which the whole of the arm mechanism 20 is within the range of the frame 6 (the state that does not protrude from the frame 6) and the like. Further, in Step S13, the auto-charging robot 2, the current operation status, such as the arm mechanism 20 and the charging connector 13 (e.g., the presence or absence of the lock of the current position and the charging connector 13 of the arm mechanism 20, etc.) and transmits information to the control device 3.

Subsequently, the control device 3, information for instructing the start of charging from the charger 1 to the vehicle 5 (charging start instruction information), and transmits to the charger 1 (Step S14). Subsequently, the charger 1 starts to charge the vehicles 5 (Step S15). Subsequently, the charger 1, when the charging of the vehicle 5 is completed (Step S16), and transmits information indicating that the charging is completed (charging completion information) to the auto charging robot 2.

Subsequently, the auto charging robot 2 unlocks the charging connector 13 (Step S17), withdrawn charging connector 13 from the charging port 53 by the arm distal end portion 24 of the arm mechanism 20 (Step S18). Subsequently, the auto-charging robot 2 returns the charging connector 13 withdrawn to a predetermined position of the charger 1 (e.g., the side of the charger 1) (step S19), to release the grip of the charging connector 13 by the arm distal end portion 24, the arm mechanism 20 to a predetermined standby position (Step S20).

Subsequently, the vehicle 5, based on an instruction of the control device 3, automatically travels from the charge space Sp1 to the standby space (Step S21). Subsequently, the user closes the charging port cover and the charging lid 54 in the standby space, rides on the vehicle 5 (Step S22), and exits the parking lot.

Although not shown in FIG. 5, in the scene where the vehicle 5 automatically travels in Steps S6, S7 and S21, by the control device 3 and the vehicle 5 is continuously communicated, automatic travel is realized. In this instance, the control device 3, for example, based on the information acquired from the infrastructure facility 4, while specifying the position of the vehicle 5, to the vehicle 5, the position of the standby space and the charging space Sp1, and sequentially transmits such travel routes to the standby space and the charging space Sp1.

Thus, the control device 3 controls the travel of the vehicle 5 in the parking lot.

In the charging system 100 according to the first embodiment described above, a plurality of charging connectors 13 are operated by one fixed arm mechanism 20 to charge a plurality of vehicles 5 simultaneously. At that time, since the arm mechanism 20 itself could not be moved, by moving the vehicle 5 during charging by inserting the charging connector 13, it is possible to charge a plurality of vehicles 5 simultaneously.

Thus, according to the charging system 100 of the first embodiment, regardless of the position and the type of parking lot of the charging port 53 of the vehicle 5, it is possible to simultaneously charge the two or more vehicles 5 by a simple configuration, and it is possible to increase the rotation rate of charging. As a result, it is possible to shorten the waiting time for charging of the user, it is possible to improve the profitability when developing the charging to the vehicle 5 as a business.

Further, by using the automatic running and automatic parking of the vehicle 5 to charge the vehicle 5, it is not necessary to wait for charging of the user, convenience of the user is improved.

Further, in the charging system 100 according to the first embodiment, a dynamics sensor 25 capable of detecting an overload due to catching of the charging cable 14, is provided on the arm mechanism 20 of the automatic charging robot 2. The dynamic sensor 25 is, for example, attached to the root of the arm tip 24. When an overload due to catching of the charging cable 14 is detected by the dynamic sensor 25, The controller 21 controls the arm mechanism 20 to reduce the operation speed of the arm mechanism 20 than just before the overload is detected to return to the previous one or two operations. Thus, as a method of removing (release) the catching of the charging cable 14, by taking a method of tracing the operation procedure of the arm mechanism 20, by releasing the catching of the charging cable 14 with a simple control, it is possible to eliminate the overload on the arm mechanism 20. Further, by reducing the operation speed of the arm mechanism 20, when releasing the catching of the charging cable 14, it is possible to suppress a large load on the arm mechanism 20. After the overload is released, the control unit 21 controls the arm mechanism 20 to return to the original operation at the time of the overload being detected by the dynamic sensor 25.

Thus, in the charging system 100 according to the first embodiment, it is possible to suppress the operation of the arm mechanism 20 is caught by the charging cable 14 is stopped.

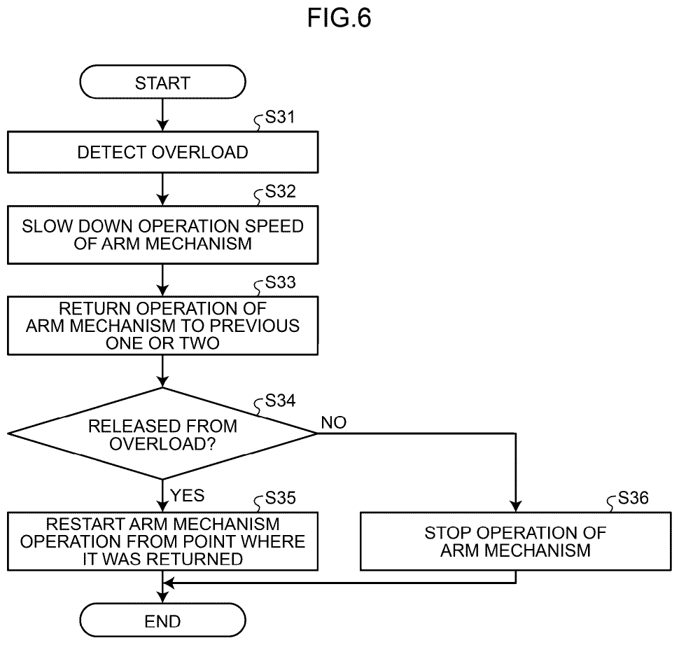

FIG. 6 is a flowchart showing an example of the control of the abnormal treatment operation performed by the control unit 21 of the automatic charging robot 2 in the charging system 100 according to the first embodiment.

First, the control unit 21 detects an overload due to catching of the charging cable 14 by the dynamic sensor 25 (Step S31). Next, the control unit 21 controls the driving device to slow the operation rate of the arm mechanism 20 (Step S32). Next, the control unit 21 controls the driving device to return the operation of the arm mechanism 20 to the previous one or two operations (Step S33). Next, the control unit 21 determines whether the overload is released

(Step S34). The control unit 21, when it is determined that the overload is released (Yes at Step S34), by controlling the drive device, restarts the operation of the arm mechanism 20 from the original operation performed before the returning of the operation (Step S35). Then, the control unit 21 terminates the control of the series of abnormality treatment operation. On the other hand, the control unit 21, when it is determined that the overload is not released (No at Step S34), controls the drive device to stop the operation of the arm mechanisms 20 (Step S36). Then, the control unit 21 terminates the control of the series of abnormality treatment operation.

As described above, in the charging system 100 according to the first embodiment, the automatic charging robot 2 is provided with a function capable of executing an abnormality treatment operation for canceling an abnormality by a simple method, so that the required time of facility management can be reduced and the operation rate can be improved.

Hereinafter, a second embodiment of a charging system provided with an automatic charging robot will be described. Incidentally, the same configuration as the first embodiment in the present embodiment will not be described.

In the charging system 100 according to the second embodiment, the camera 23 provided in the automatic charging robot 2 has a function that can recognize the operation status of the arm mechanism 20. The camera 23 can communicate with the control unit 21 of the automatic charging robot 2, and can send image information from the camera 23 to the control unit 21. The control unit 21 is equipped with an artificial intelligence (AI) in a portion for processing the image information from the camera 23. Then, the control unit 21, when detecting the image information indicating the catching of the charging cable 14, incorporates a program for stopping the operation of the arm mechanism 20. The AI of the control unit 21 has a function of calculating the coordinate position on the coordinate consisting of X-axis and Y-axis and axial of the operation of the arm mechanism 20, and is capable of determining the catching of the charging cable 14 based on the coordinate position of the arm mechanism 20 and the image information. Further, the control unit 21 has a function to temporarily interrupt the calculated results of AI in the operation program of the arm mechanism 20, when determining the catching of the charging cable 14, and is capable of performing the abnormal treatment operation of the arm mechanism 20 automatically to remove the catching of the charging cable 14. Thus, in the charging system 100 according to the second embodiment, it is possible to suppress the operation of the arm mechanism 20 is caught by the charging cable 14 is stopped.

As a camera having a function capable of recognizing the operation status of the arm mechanism 20, separately from the camera 23 for imaging the charging port 53 may be provided in the arm mechanism 20.

FIG. 8 is a flowchart showing an example of the control of the abnormal treatment operation performed by the control unit 21 of the automatic charging robot 2 executed by the charging system 100 according to the second embodiment.

First, the control unit 21 detects the catching of the charging cable 14 based on the image information from the camera 23 (Step S41). Next, the control unit 21 controls the drive unit to stop the operation of the arm mechanism 20 (Step S42). Next, the control unit 21 calculates the operation direction of the arm mechanism 20 for releasing the catching of the charge cable 14 using the AI (Step S43). Next, the control unit 21, based on the calculated result by the AI, controls the drive unit to execute the catching release operation of the charge cable 14 (Step S44). Then, the control unit 21 terminates the control of the series of abnormal processing operation.

As described above, in the charging system 100 according to the second embodiment, the abnormal state of the catching of the charging cable 14, objectively viewed by the camera 23, it is possible to execute the abnormal treatment operation automatically by the automatic charging robot 2. Accordingly, in the charging system 100 according to the second embodiment, it is possible to treat even high-level catching abnormality without human intervention, thereby reducing the time required for facility management and improving the operation rate.

Hereinafter, a third embodiment of a charging system provided with an automatic charging robot according to the present disclosure will be described. Incidentally, the same configuration as the first and second embodiments in the present embodiment will not be described.

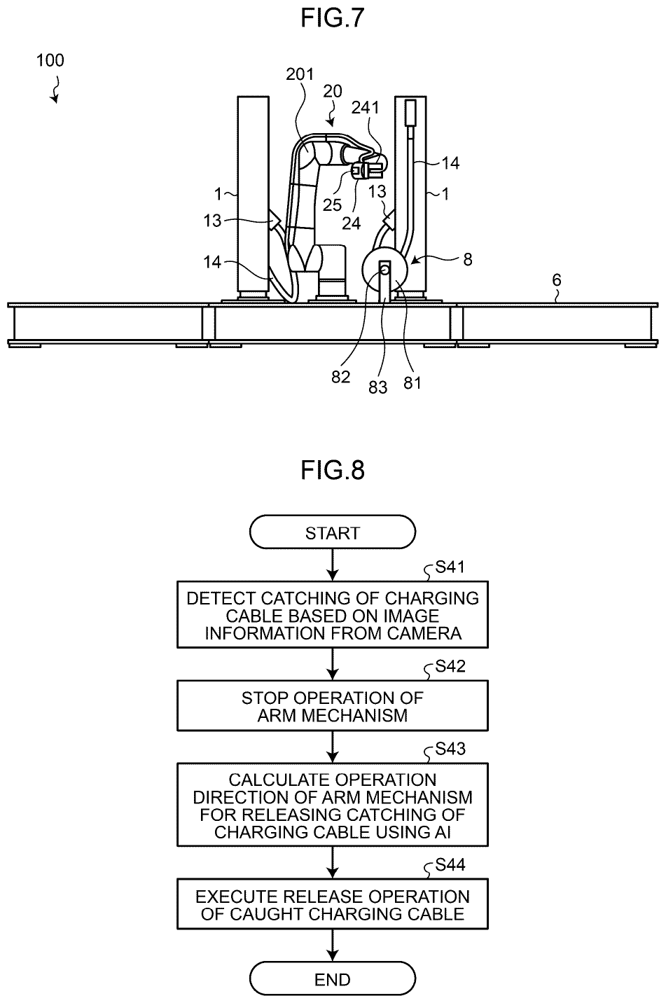

FIG. 7 is a side view showing a schematic configuration of a charging system 100 according to the third embodiment.

As shown in FIG. 7, the charging system 100 according to the third embodiment includes a cable winder 8 which is a mechanism for winding the charging cable 14 to the charger 1. The cable winder 8 is configured by a drum-shaped reel portion 81 rotatably supported by a support member 83 which is fixed on a frame 6 near the charger 1 via a rotary shaft 82. Further, the cable winder 8 is configured to be able to automatically wind up, by the force of the spring, the charging cable 14 (pulled out) unwound from the reel portion 81. Therefore, when inserting the charging connector 13 into the charging port 53 of the vehicle 5, the automatic charging robot 2 operates the arm mechanism 20 to unwind (pull out) the charging cable 14 against the force of the spring of the cable winder 8.

Thus, the cable winder 8 is configured to unwind (pull out) the charging cable 14 wound by the reel portion 81 with the minimum necessary length, for example, only the length necessary for the charging connector 13 to move between the predetermined position of the charger 1 (side of the charger 1) and the charging port 53 of the vehicle 5. In the charging system 100 according to the third embodiment, it is possible to adopt a hardware structure in which the catching of the charging cable 14 is physically suppressed because the cable winder 8 only unwind (pull out) the minimum length necessary. Thus, in the charging system 100 according to the third embodiment, it is possible to suppress the stopping of the operation of the arm mechanism 20 due to the catching of the charging cable 14.

Thus, in the charging system 100 according to the third embodiment, it is possible to reduce the frequency of abnormality occurrence due to catching of the charging cable 14 at low cost, it is possible to improve the reduction and the operation rate of the required time of facility management.

The automatic charging robot according to the present disclosure, by releasing the catching of the charging cable with a simple control, it is possible to suppress the operation of the arm mechanism is caught by the charging cable is stopped. Further, when releasing the catching of the charging cable, it is possible to suppress a large load on the arm mechanism.

Moreover, the automatic charging robot according to the present disclosure, the abnormal state of catching of the charging cable, objectively viewed by the camera, to execute the catching release operation of the charging cable to the arm mechanism, the charging cable is caught it is possible to suppress the operation of the arm mechanism is stopped.

Further, the automatic charging robot according to the present disclosure, by the charging cable being pulled out with the minimum length, it is possible to adopt a structure that physically suppressing the catching of the charging cable.

Further, according to the charging system according to the present disclosure, it is possible to suppress the operation of the arm mechanism is stopped by the catching of the charging cable.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An automatic charging robot comprising:
an arm mechanism configured to grip a charging connector connected to a charging device via a charging cable;
a control device configured to automatically perform control of an operation of the arm mechanism; and
a dynamic sensor provided in the arm mechanism and configured to detect an overload due to catching of the charging cable, wherein
the control device is configured to control the operation of the arm mechanism to:
return to a previous one or two operations when the overload has been detected by the dynamic sensor; and
return to the operation when the overload has been detected after the overload is released.

2. The automatic charging robot according to claim 1, wherein the control device is configured to control the arm mechanism to reduce an operation speed in a case where the arm mechanism is controlled to return to the previous one or two operations when the overload has been detected.

3. An automatic charging robot comprising:
an arm mechanism configured to grip a charging connector connected to a charging device via a charging cable;
a control device configured to automatically perform control of an operation of the arm mechanism; and
a camera provided in the arm mechanism and configured to capture an image regarding to catching of the charging cable and generate image information based on the captured image, wherein
the control device is configured to
calculate a direction to operate the arm mechanism for releasing the catching of the arm mechanism based on the image information, and
control the arm mechanism to perform an operation to release the catching of the charging cable based on the calculated direction.

4. An automatic charging robot comprising:
an arm mechanism configured to grip a charging connector connected to a charging device via a charging cable;
a control device configured to automatically perform control of an operation of the arm mechanism; and
a cable winder configured to wind the charging cable, wherein
the control device is configured to control the cable winder to pull out the charging cable with a minimum necessary length.

5. An automatic charging system comprising:
a charging device including a charging connector and a charging cable connected to the charging connector; and
the automatic charging robot according to claim 1.

6. An automatic charging system comprising:
a charging device including a charging connector and a charging cable connected to the charging connector; and
the automatic charging robot according to claim 2.

7. An automatic charging system comprising:
a charging device including a charging connector and a charging cable connected to the charging connector; and
the automatic charging robot according to claim 3.

8. An automatic charging system comprising:
a charging device including a charging connector and a charging cable connected to the charging connector; and
the automatic charging robot according to claim 4.
